(19) United States
(12) Patent Application Publication
(10) Pub. No.: US 2008/0095068 A1
(43) Pub. Date: Apr. 24, 2008

(54) Apparatus and method for measuring one way packet network characteristics at a specific protocol level

(75) Inventor: Sezen Uysal, Vienna, VA (US)

Correspondence Address: SEZEN UYSAL, 9318 KILBY GLEN DR., VIENNA, VA, 22182, US

(73) Assignee: Mr. Sezen Uysal, Vienna, VA (US)

(21) Appl. No.: 11/875,834

(22) Filed: Oct. 20, 2007

Related U.S. Application Data
(60) Provisional application No. 60/862,230, filed on Oct. 20, 2006.

(51) Int. Cl. H04L 12/26

(52) U.S. Cl. 370/252

(57) ABSTRACT

This invention is an apparatus and a method to measure packet network characteristics such as latency, jitter, bandwidth, packet loss, in one way of the traffic at any protocol or application level such as VoIP, HTTP, MPLS, etc. In addition, round trip measurements can be performed by combining one way measurements in both directions. The invention can be used on any type of packet networks.

### BACKGROUND OF INVENTION

Network measurement is very important for determining the health of production networks as well as engineering test ones. There are many methods, products and vendors that provide solutions for making measurements to get characteristics of a network such as latency, packet loss, jitter, bandwidth as well as other behaviors of packets like amount of duplicate and amount of out-of-order packets. However all of these solutions provide measurements for round trip traffic.

Nowadays traffic patterns (e.g. web traffic) and most of the access networks (e.g. ADSL, cable) are asymmetric. Therefore making round trip measurements does not characterize these applications and networks well.

This invention proposes a solution to make one-way network characteristics measurements at any protocol level by using external clock synchronizations and inbound management packets.

### SUMMARY OF INVENTION

This invention is an apparatus and a method to measure packet network characteristics such as latency, jitter, bandwidth, packet loss, in one way of the traffic at any protocol or any application level such as VoIP, HTTP, MPLS, etc. In addition, round trip measurements can be performed by combining one way measurements in both directions. The invention can be used on any type of packet networks.

Measurements are made by injecting packets from one apparatus to the other one. As the apparatus is capable of generating any type of packets, measurements can be performed at any protocol level such as Ethernet, IP, TCP, MPLS, VLAN, etc. For example, with this invention it is possible to measure available bandwidth and latency for the VoIP service, or for a specific MPLS label in a complex network with various types of traffic, from one location to another.

This invention uses external clock synchronization for each the invention unit to make accurate one way measurements. By using globally synchronized reliable clock sources such as Global Positioning System (GPS), GSM or CDMA cell phone networks, or atomic clock sources, it is possible to synchronize two apparatuses. From these clock sources, synchronization margins are small enough for accurate network measurements. The invention use special data packets to synchronize each other as well as conduct measurements inbound with the traffic.

### BRIEF DESCRIPTION OF DRAWINGS

FIG. 1 shows a typical network topology in which two apparatuses getting accurate clock information from two different external clock sources at different locations. The Network Under Test (NUT) is characterized by making one way measurements in each direction from both apparatuses.

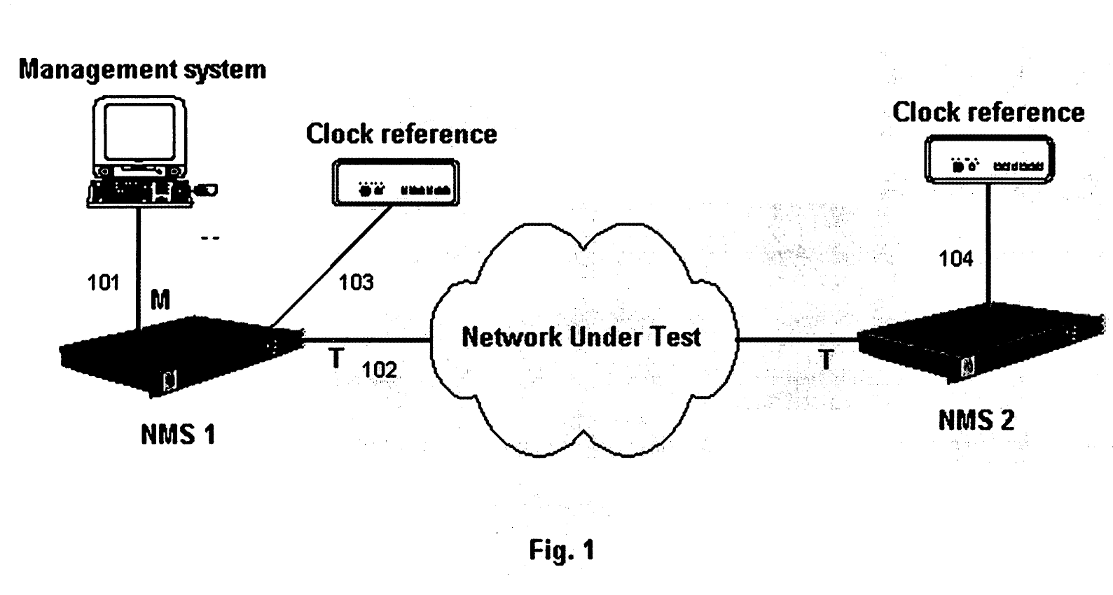

### DETAILED DESCRIPTION

The invention is managed remotely by a management PC (101). At least two apparatuses will be placed at critical positions in the Network Under Test (NUT) to conduct measurements between these two points. (102)

Before starting the measurements, each apparatus needs to synchronize its time to closest reliable clock source via NTP protocol, or via GSM, GPS or CDMA network. Time synchronization of individual apparatus is possible by one of many commercial solutions. (103, 104)

The apparatus uses special packets sent inbound for time synchronization, measurement requests and results to each other.

The invention uses an application on each apparatus. This application runs in client-server mode. The server once started will be continuously running in the background. The client will connect the server to send commands to perform time synchronization and to start measurement tests. The server in return connects to one or more clients, initiates its time synchronization, and responds to clients with measurement packets.

The invention is capable of generating any type of protocol packets. Therefore it is able to measure traffic characteristics at any protocol or application level.

At the end of each test, the client requests the server for a summary response packet, which will have a report of all the measurement information collected by the server.

The invention provides a unique capability for unidirectional latency measurements. For latency tests, both clients and server will time stamp packets. Both client and server will measure the latency by measuring the time difference between packet's receive time and the corresponding time stamp. Both server and client will notify each other with previously measured latency value. Similarly, jitter can be measured as time difference between real packet arrival time and the expected arrival time.

For packet loss, out-of-order-packet measurements, and duplicate packet measurements, each packet will have two sequence numbers; the client sequence number will be set by the client and will be incremented by one for each new packet sent. Similarly, server sequence number will be set by the server. This way independent measurement can be done on each direction.

Both sides will check the sequence numbers and keep track of missing numbers for reporting packet loss, and out-of-order packets. Similarly, if more than one packet received with the same sequence numbers duplicate packet counter will be incremented.

For the bandwidth measurements, the client sends fixed size packets (e.g. 1500 byte) to the server for a fixed amount of time. At the end of this duration the server will calculate the cumulative number of bits received every second, and report the computed bandwidth to the client.

1. An apparatus for measuring network characteristics such as latency, jitter, bandwidth, packet loss, etc. in one way at any protocol level by sending packets to another apparatus over the network under test.

2. An apparatus as described in claim 1, wherein all the apparatuses are time synchronized by external reliable time sources such as NTP servers, or GSM, GPS, CDMA networks.

3. An apparatus as described in claim 1, wherein all the apparatuses generate packets for the protocol level such as HTTP, VoIP, MPLS, IP, Ethernet, etc. in which network measurements are conducted; the packets containing time stamps and sequence numbers used for the measurements of one-way latency, packet loss, duplicate packets, out-of-order packets and the bandwidth.

4. An apparatus as described in claim 1, wherein apparatuses run applications in client-server mode for initiating synchronizations, measurements from one apparatus to the other, and make one-way measurements for each direction, requesting and responding measurement reports, and errors.

5. A method for measuring network characteristics such as latency, jitter, bandwidth, packet loss, etc. in one way at any protocol level by sending packets to other point over the network under test.

6. A method as described in claim 1, wherein the method requires synchronization by external reliable time sources such as NTP servers, or GSM, GPS, CDMA networks.

7. A method as described in claim 1, wherein the method generates packets for the protocol level such as HTTP, VoIP, MPLS, IP, Ethernet, etc. in which network measurements are conducted; the packets containing time stamps and sequence numbers used for the measurements of one-way latency, packet loss, duplicate packets, out-of-order packets and the bandwidth.

8. A method as described in claim 1, wherein the method runs applications in client-server mode for initiating synchronizations, measurements from one point to the other, and make one-way measurements for each direction, requesting and responding measurement reports, and errors.
